(19) United States
(12) Patent Application Publication
(10) Pub. No.: US 2003/0027576 A1
(43) Pub. Date: Feb. 6, 2003

(54) Method and apparatus for providing call recipient local information for pervasive communication devices

(75) Inventors: Gregory P. Fitzpatrick, Keller, TX (US); David B. Lebowitz, North Richland Hills, TX (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 09/919,391

(22) Filed: Jul. 31, 2001

(51) Int. Cl. H04Q 7/20

(52) U.S. Cl. 455/445; 455/412; 455/414; 455/461

(57) ABSTRACT

The present invention provides a method and system for providing call recipient local information for pervasive communication devices. An originating subscriber places a call through it service provider to a receiving subscriber. Prior to connecting the call, the current time at the receiving subscriber location can be determined. The originating subscriber will be notified of the time at the subscriber's location. Based on the time at the subscriber's location and the urgency of the call, the originating subscriber can decide whether the call should be connected. Upon notifying the originating subscriber of the recipient's local time, the system can provide a prompt that allows the originating subscriber to allow connection or to defer connection. Deferring the connection can include placing the call at a more appropriate time or allowing the call to be sent to a mailbox which is associated with the receiving subscriber.

### BACKGROUND OF THE INVENTION

1. Technical Field

The present invention relates to the field of data communications, and more particularly to a method and apparatus for providing call recipient local information to a pervasive communication device.

2. Description of the Related Art

The pervasiveness of wireless technology and the Internet have created a niche for handheld devices, hereinafter, pervasive communication devices (PCDs), used to access various services offered by wireless service providers. These PCDs can include, but are not limited to, personal digital assistants, PDA, wireless telephones, pagers and handheld computers. Several consortiums have been formed to provide standard interfaces for these handheld devices. The Wireless Application Protocol (WAP) Forum and Third Generation Partnership Project (3GPP) are exemplary consortiums. WAP is a de facto protocol which defines a communication standard for wireless information and telephony services.

WAP utilizes existing Internet standards such as hypertext transfer protocol (HTTP), extensible markup language (XML) and Internet Protocol (IP) for providing wireless services. For example, existing XML syntax is utilized to provide a syntax for a new wireless markup language (WML). Moreover, WAP utilizes existing application development methodologies such as common gateway interface (CGI), active server pages (ASP), network server application program interface (NSAPI), Java, and Servlets (a Java program that extends the functionality of a Web server, generating dynamic content and interacting with Web clients using a request-response paradigm) to provide content to subscribers having PCDs.

Notably, given the large market penetration of these PCDs and the need to gain immediate market share, it is critical that new standards, such as WAP and 3GPP, provide communication components that map onto existing mobile device interfaces and platforms when offering new services. While subscribers having these PCDs crave for these new services, the maintenance of a subscribers privacy is tantamount to the use of any new service. Significantly, even though a subscribers' desire is to be connected all the time independent of location, the subscriber always wants to maintain the autonomy of receiving a call only when it is appropriate to do so.

For example, when a subscriber travels outside a home time zone (or dateline), a caller might not know what time is convenient to place a call to the traveling subscriber. Therefore, the subscriber's privacy and solitude can be compromised by the receipt of unimportant calls at peculiar hours. Consequently, a service is needed wherein a subscriber using a pervasive communication device PCD can maintain privacy associated with the autonomy of receiving calls when it is appropriate to do so.

### SUMMARY OF THE INVENTION

The invention discloses a method and apparatus for providing call recipient local information for a pervasive communication device (PCD). The method can include the steps of determining information which is local to a receiving PCD in response to a call received from an originating PCD. The determined local information can be provided to the originating PCD. The call can subsequently be connected based on the provided information. The local information can be any one or more of a time, a date and a location where the receiving PCD is currently stationed. The local information can be determined by acquiring the information from a time source.

A method for call recipient local information for a pervasive communication device (PCD) is also provided by the invention. The method can include the steps of initiating a call from an originating PCD to a receiving PCD and receiving local information from a service provider servicing the receiving PCD. The call can accordingly be disposed of based on the received local information. The local information can include any one or more of a time, a date and a location where the receiving PCD is stationed. The information can be determined by acquiring the information from a time source. The disposing step can include, selecting an action from the group of actions consisting of permitting the connection of the call to the receiving PCD, permitting connection of the call to a voice mail, and disconnecting the call. For example, if the information dictates that the called party should not be disturbed, then the call can be disconnected or routed to a voicemail.

A system for providing call recipient local information for a pervasive communication device is also disclosed. The system can include an originating PCD which initiates a call to a receiving PCD and a time source for reporting local information at the receiving PCD. A service provider can dispose of the call based on an input response received from the originating PCD and/or the local information. For example, the input can be a tone generated by pressing a numeric or alphanumeric key on the PCD.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a block diagram of an exemplary system for providing call recipient local information; and

FIG. 2 is a call flow diagram used to illustrate exemplary calling procedures consistent with the inventive aspects.

### DETAILED DESCRIPTION OF THE INVENTION

The present invention provides a method and system for providing call recipient local information for pervasive communication devices. An originating (calling) subscriber can place a call through their caller's service provider to a receiving (called) subscriber. Prior to connecting the call, information such as the current time at the receiving subscribers' location, can be determined and the originating subscriber can be notified of the information. Based on the information and the urgency of the call, the originating subscriber can decide whether the call should be connected. For example, upon notifying the originating subscriber of the recipient's local time, the system can provide a prompt that allows the originating subscriber to defer the connection. Deferring the connection can include placing the call at a more appropriate time or allowing the call to be sent to a voice mailbox which is associated with the receiving subscriber.

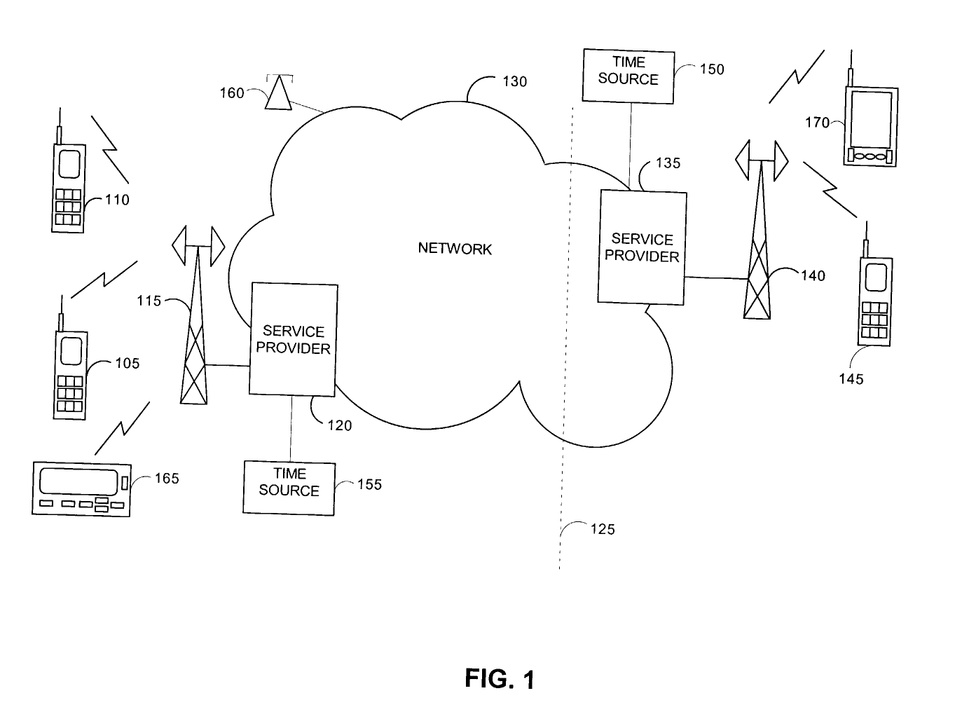

There is shown in FIG. 1, a diagram of an exemplary system for providing call recipient local information. Referring to FIG. 1, there are shown PCDs 105, 110, 165, 145, 170, service providers 120, 135, wireless base stations 115, 140, network 130, PSTN telephone 160 and a time source 150, 155. PCDs 105, 110, 165, 145, 170 can be wireless devices capable of handling voice encoded signals and data communication signals. PCDs 105, 110, 165, 145, 170 typically have a keypad that permits alphanumeric input. Some PCDs are sophisticated enough to handle speech enabled input. PCDs also have a display, typically LCD, the functionality of which may vary according to sophistication. The two basic functions of the display are input and output (I/O). A PCD can have a touch sensitive display that acts both as an input and an output device. For example, some PCDs have a display that can simultaneously provide viewing and input via special shorthand symbols. This permits manipulation of the data content being viewed.

Service provider 120 provides wireless service to PCDs 105, 110, 165 via wireless base station 115. Similarly, service provider 135 provides wireless service to PCD 145 via wireless base station 140. Service providers providing access to services to PCDs are well known in the art. For example, service providers can use wireless systems such as advanced mobile phone system (AMPS), time division multiple access (TDMA), global system for mobile communication (GSM) and code division multiple access (CDMA) are commonly used to provide wireless service to PCDs. Although it can be inferred that service providers 120, 135 are different companies, the service provider can be the same company. In the latter instance, service providers 120 and 135 can be in located different geographic areas.

Wireless base stations 115 can be used by service provider 120 to provide service access for PCDs 110, 115 and 165. Similarly, wireless base stations 140 can provide service to PCDs 145, 170. Exemplary access methodology employed by the wireless base stations 120, 140 can include AMPS, CDMA, wideband CDMA (WCDMA), GSM. The scalabality of the wireless base stations is not necessary to the practice of the invention. Accordingly, base station 140 can be a cell site, a minicell, a microcell, or a pico cell.

Network 130 acts as a conduit for communicating signals between service providers 120, 135. Network 130 can also provide connectivity for PSTN telephone 160 to communicate with service providers 120, 135. The underlying access and transport technology utilized by network 130 is not necessary to the practice of the invention. Accordingly, network 130 can be a wireless or wired network, an intranet, the Internet, a wide area network (WAN) or any combination thereof. Conventional wireline (PSTN) telephone 160 can be part of a PSTN which has connectivity to network 130. PSTN telephones such as telephone 160, are well known in the art of communications.

The time source 150 can be a dedicated “time-of-day” (TOD) server that can be used to provide time signals to the service provider 135. Since a service provider can have base stations which may be located in different time zones, the TOD server can have the capability of independently tracking and reporting time for each base station. The TOD can be synchronized to a standardized time such as Greenwich Mean Time (GMT) and accordingly make adjustments based on time zone location. It is known to synchronize an electronic timing device to a caesium atomic clock using RF signals. For example, if the PCD 145 is located in Sydney Australia, then the local time in Sydney would be 10 hours ahead of the GMT.

In accordance with the inventive arrangements, an originating subscriber using PCD 105 (for example, a PCS telephone) can place a call through service provider 120 via the serving wireless base station 115. The call is destined to a receiving subscriber utilizing PCD 145 (for example, a PCS telephone). Service provider 120 can route the call through network 130 to service provider 135 which is currently providing service to the receiving PCD 145. Prior to alerting PCD 145 of an incoming call, the originating (calling) subscriber can be notified of information local to the receiving (called) subscriber. The local information can include, but is not limited to, the day of the week, the local and/or standard time of the day and the geographic location of the receiving subscriber.

The notification to the originating subscriber can be automatic or manual. Manually providing notification can include providing a prompt which allows the originating subscriber to decide whether or not to get the local information. For example, the calling party could be prompted to “press 1” to hear the local information, or otherwise “press 2” to continue with the call. Automatically providing notification can include providing the local information without prompting the originating subscriber. If the originating PCD is located in Florida, USA, where it is Thursday Apr. 26, 1:00 pm, then GMT would be Thursday Apr. 26, 6:00 pm. Hence, an exemplary notification can be “It is now 4:00 am on Friday Apr. 27 in Sydney Australia.” An alternate exemplary notification can be “It is now Thursday Apr. 27, 6:00 pm GMT or 4:00 am on Friday Apr. 27 in Sydney Australia.” If the caller does not wish the location to be disclosed, then an alternate message can be “It is now Thursday Apr. 26, 6:00 pm GMT or 4:00 am on Friday Apr. 13 at the called party's location.”

Local time source 150 can be used to provide local information including date, time and location. Upon receipt or initiation of a call by a service provider, for example 135, service provider 135 can query time source 150 with a request for the date and/or time. The time source 150 can determine the data and/or time and send it to the service provider 135. The service provider 135, can provide this information to the calling subscriber in the form of a voice prompt. Depending on the urgency of the call, the originating caller can chose to continue with the call, terminate the call, or leave a message in a voice mailbox. If the originating party chooses to continue with the call, then the receiving terminal will be alerted of the incoming call, by for example, a ring. If the originating party determines that the urgency does not necessitate disturbing the receiving party, then the originating party can hangup or leave a message.

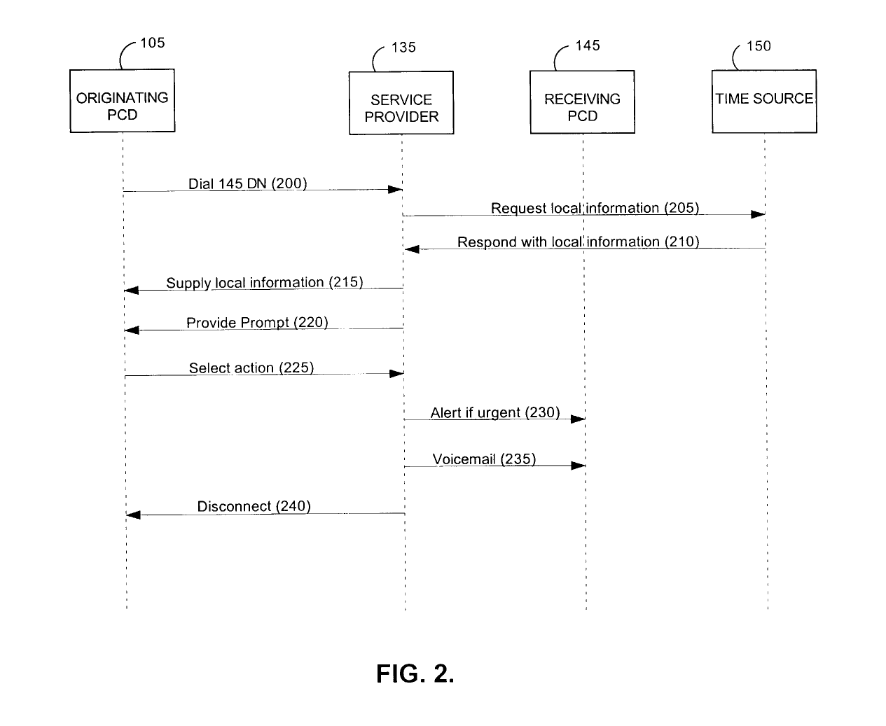

FIG. 2 is a call flow diagram used to illustrate exemplary calling procedures consistent with the inventive aspects. In step 200, a subscriber utilizing originating PCD 105 initiates a call to receiving PCD 145 by dialing PCD's 145 directory number (DN). The call is routed through network 130 to service provider 135 which is providing coverage to PCD 145. In step 205, the service provider 135 sends a request for local information to the time source 150. Upon receipt of the request, time source 150 responds in step 210 by sending the local information to the service provider 135. This local information can include, the day, the date and the time which can be provided in a localized and/or standardized format. An informational signal containing the local information can be sent by service provider 135 to the originating mobile station as illustrated in step 215. Service provider 135 can provide an optional prompt as shown in step 220, which can facilitate disposition of the call. In step 225, the subscriber using PCD 105 can respond to the prompt by selecting an appropriate action as requested by the prompt. The prompt can be presented to PCD 105 in the form of a voice prompt or as a text based prompt that can be displayed on the display screen of PCD 105. If it is determined that the call is urgent, then service provider 135 can continue the call connection procedure by sending an alert signal to the receiving PCD 145 as illustrated in step 230. The alert signal can be a ringing tone. If it is determined that the call does not warrant disturbing the subscriber using PCD 145, then the call can be sent to a voicemail as shown in step 235. If it is determined that the call should be disconnected, then a disconnect signal can be sent to the originating PCD and call resources relinquished as shown in step 240. In any event, the disconnect signal sent in step 240 is utilized to terminate the call.

It should be readily understood that the originating subscriber, for example 105, does not have to be calling from a pervasive device. Instead, the originating subscriber can be a PSTN subscriber using conventional wireline telephone 160. Furthermore, although the call can be a voice call, the call can also be a data call. For example, the call can be a text based message to be displayed on PCD 170.

The present invention can be realized in hardware, software, or a combination of hardware and software. A method and apparatus for providing call recipient location information for pervasive communication devices according to the present invention can be realized in a centralized fashion in one computer system, or in a distributed fashion where different elements are spread across several interconnected computer systems. Any kind of computer system, or other apparatus adapted for carrying out the methods described herein, is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

We claim:

1. A method for providing call recipient local information comprising the steps of:
identifying an attempt to establish a telephone call between an originating call source and a receiving handheld device;
responsive to said identification, determining information local to said receiving handheld device; and,
providing said determined local information to said originating call source, said originating call source deciding whether to complete said telephone call or terminate said telephone call based upon said determined local information.

2. The method according to claim 1, wherein said local information comprises information selected from the group consisting of a time, date, day and location where said receiving handheld device is located.

3. The method according to claim 2, wherein said local information is determined by acquiring said information from a time source.

4. A method for providing call recipient local information comprising the steps of:
initiating a call between an originating call source and a receiving handheld device;
receiving local information from a service provider which services said receiving handheld device; and
processing said call based on said received local information.

5. The method according to claim 4, wherein said local information comprises information selected from the group consisting of a time, date, day and location where said receiving handheld device is located.

6. The method according to claim 4, wherein said local information is determined by acquiring said information from a time source.

7. The method according to 4, wherein said processing step comprises, selecting an action from the group of actions consisting of connecting said call to said receiving handheld device, connecting said call to a voice mail box, and disconnecting said call.

8. A system for providing location-based call recipient information comprising:
a wireless service provider for providing wireless telephony services to a network of handheld devices;
a time source for electronically reporting information local to each of said handheld devices; and,
a notification system configured to provide local information acquired from said time source in response to an attempt to establish a connection between an originating call source and a handheld device in said network, said notification system being further configured to provide said local information prior to establishing said connection, said notification being yet further configured to delay establishing said connection until a decision to affirmatively establish said connection is made at said originating call source based on said provided local information.

9. A machine readable storage having stored thereon, a computer program having a plurality of code sections, said code sections executable by a machine for causing the machine to perform the steps of:
identifying an attempt to establish a telephone call between an originating call source and a receiving handheld device;
responsive to said identification, determining information local to said receiving handheld device; and,
providing said determined local information to said originating call source, said originating call source deciding whether to complete said telephone call or terminate said telephone call based upon said determined local information.

10. The machine readable storage according to claim 9, wherein said local information comprises information selected from the group consisting of a time, date, day and location where said receiving handheld device is located.

11. The machine readable storage according to claim 10, wherein said local information is determined by acquiring said information from a time source.

12. A machine readable storage having stored thereon, a computer program having a plurality of code sections, said code sections executable by a machine for causing the machine to perform the steps of:
initiating a call between an originating call source and a receiving handheld device;
receiving local information from a service provider which services said receiving handheld device; and
processing said call based on said received local information.

13. The machine readable storage according to claim 12, wherein said local information comprises information selected from the group consisting of a time, date, day and location where said receiving handheld device is located.

14. The machine readable storage according to claim 12, wherein said local information is determined by acquiring said information from a time source.

15. The machine readable storage according to 12, wherein said processing step comprises, selecting an action from the group of actions consisting of connecting said call to said receiving handheld device, connecting said call to a voice mail box, and disconnecting said call.
